(19) United States
(12) Patent Application Publication
(10) Pub. No.: US 2018/0040209 A1
(43) Pub. Date: Feb. 8, 2018

(54) INFORMATION COMMUNICATION TECHNOLOGY-BASED UNMANNED ALERT SYSTEM

(71) Applicant: DEANS CO., LTD, Seoul (KR)

(72) Inventor: Seong Ho LIM, Seoul (KR)

(73) Assignee: DEANS CO., LTD, Seoul (KR)

(21) Appl. No.: 15/553,986

(22) PCT Filed: Apr. 15, 2015
(86) PCT No.: PCT/KR2015/003768

§ 371 Date: Aug. 26, 2017

(30) Foreign Application Priority Data
Feb. 26, 2015 (KR) 10-2015-0027304

(51) Int. Cl. G08B 5/36; H02S 10/12; G08B 25/00; G08B 27/00; G08B 5/22; G08B 13/196

(52) U.S. Cl. CPC G08B 5/36; G08B 5/226; G08B 13/1963; G08B 13/19656; G08B 25/009; G08B 27/005; H02S 10/12

(57) ABSTRACT

The present invention provides an information communication technology-based unmanned alert system for autonomously determining whether an intruder is present, notifying a user of invasion information, using a 4G LTE network, and forcing the intruder out. The present invention comprises: an unmanned monitoring device (20) comprising an information collection unit for collecting surrounding situation information, a wireless communication unit for a monitoring device, which wirelessly transmits or receives information, using an LTE communication scheme, and a first control unit for transmitting or receiving information collected by the information collection unit through the wireless communication unit for a monitoring device; and a mobile terminal (50) comprising a wireless communication unit for a terminal, which wirelessly transmits or receives information to or from the wireless communication unit for a monitoring device, and a second control unit for displaying, on a display unit, surrounding situation information received by a wireless transmission unit for a terminal. Therefore, the unmanned monitoring device (20) transmits or receives intruder information to or from the mobile terminal (50) through an image and a text, so that a watcher can understand the intruder information.

### TECHNICAL FIELD

The present invention relates to an information communication technology (ICT)-based unmanned security system for collecting peripheral status information using various types of unmanned surveillance devices, and wirelessly transmitting the collected information to a mobile device using a long term evolution (LTE) network.

### BACKGROUND ART

Currently, for basic military deterrence, the Republic of Korea essentially requires an efficient security system for blocking intruders from the Democratic People's Republic of Korea.

The Republic of Korea is bounded by the sea on three sides and by the land on one side. Therefore, enemies can intrude from both the land (e.g., the demilitarized zone (DMZ)) and the sea, and coastal areas are very vulnerable to intrusion.

Compared to land surveillance areas, coastal surveillance areas are very wide and do not have sufficient troops, and thus no-surveillance zones can occur.

To solve the difficulties of surveillance, required is development of a technology capable of checking movements of an enemy in real time using an unmanned surveillance device, of checking a current status within a short time by wirelessly and simultaneously transmitting the checked information to a decision maker, a person in charge of an operational force, etc., and of accurately checking the status of an operational area before the operational force is deployed in combat based on wireless control of an unmanned security system by the decision maker or the like. A closed-circuit television (CCTV), which is an unmanned surveillance device commonly used in daily life, directly transmits a signal using a cable and does not externally transmit a radio signal. Unlike a general broadcasting system for transmitting a radio signal receivable by anyone, the CCTV, as the name implies, transmits an image only to a cable-connected device of a certain person.

However, image information obtainable by merely installing a camera on a pole and moving the camera in vertical and horizontal directions is very restrictive and is very vulnerable to fog, nighttime, and rain.

### DISCLOSURE

### Technical Problem

Therefore, the present invention has been made in view of the above problems, and it is one object of the present invention to provide an information communication technology (ICT)-based unmanned security system capable of improving surveillance performance thereof by monitoring a surveillance area using an information collection unit configured as a fusion sensor, determining whether a detected object is an intruder, and wirelessly and simultaneously transmitting the determination information to a plurality of users.

It is another object of the present invention to provide an ICT-based unmanned security system capable of checking movements of an intruder (enemy) in real time using an unmanned surveillance device, of checking a current status within a short time, and of accurately checking the status of an operational area before an operational force is deployed in combat based on wireless control of the unmanned security system by a decision maker.

It is another object of the present invention to provide an ICT-based unmanned security system capable of checking characteristics of an intruding object, and of warning or displacing the intruder by emitting high-luminance light from a light-emitting means.

It is another object of the present invention to provide an ICT-based unmanned security system capable of improving convenience of control and reliability using a wireless communication method.

It is yet another object of the present invention to provide an ICT-based unmanned security system capable of improving performance of detection and enabling rapid reactions by integrating an information collection unit and a controller to determine whether a detected object is an intruder, immediately after the object is detected by a sensor.

### Technical Solution

In accordance with one aspect of the present invention, provided is an information communication technology (ICT)-based unmanned security system including an unmanned surveillance device including an information collection unit for collecting peripheral status information, a surveillance device wireless communication unit for wirelessly transmitting and receiving information using a long term evolution (LTE) communication method, and a first controller for transmitting or receiving the information collected by the information collection unit, through the surveillance device wireless communication unit, and a mobile device including a mobile device wireless communication unit for wirelessly transmitting and receiving information to and from the surveillance device wireless communication unit, and a second controller for displaying the peripheral status information received through the mobile device wireless communication unit, on a display unit.

When a remote control signal is transmitted through the mobile device wireless communication unit, the remote control signal may be received through the surveillance device wireless communication unit and the unmanned surveillance device may be driven based on the received remote control signal.

When a plurality of mobile devices are present, the unmanned surveillance device may simultaneously transmit the collected peripheral status information to the plurality of mobile devices using LTE communication.

The unmanned surveillance device may include a power source mounted on a body to autonomously generate and supply electricity required for operation, the information collection unit mounted on the body and configured as a fusion sensor including a radar for monitoring a surveillance area and an infrared sensor for detecting infrared light, and the first controller for receiving a signal detected by the information collection unit, determining whether a detected object is an intruder, and transmitting or receiving the collected information through the surveillance device wireless communication unit if the detected object corresponds to a preset intruder determination criterion.

The first controller may be integrated with the body and may include embedded software in which the intruder determination criterion is set as a case when an object over 40 kg moves at 0.1 meter per second (m/s) or faster, to generate a detection signal.

A light-emitting means for emitting light if the first controller determines an intruder may be further mounted on the body.

The first controller may include a determination unit having stored the intruder determination criterion therein to receive a signal generated by the information collection unit, to determine whether a detected object is an intruder, and to generate a detection signal, and a warning controller for controlling emission of the light-emitting means based on determination of the determination unit.

The light-emitting means may include a high-luminance light-emitting diode (LED) searchlight.

The information collection unit may further include a camera for capturing an image of a surveillance area or an intruding object.

A composite hinge may be further mounted on the body, the composite hinge may include a fixed part mounted on the body, a first rotatable part rotatably mounted on the fixed part, and a second rotatable part rotatably mounted on the first rotatable part to rotate about a rotation axis crossing the rotation axis of the first rotatable part, and the camera and the light-emitting means for emitting light may be mounted on the second rotatable part. The camera may have a speaker and a microphone embedded therein and may capture an image if the first controller determines that the detected object is an intruder.

The power source may include a solar power generator mounted on the body to generate electricity using solar energy and to store the electricity, and a wind power generator mounted on the body to generate electricity using wind power and to store the electricity.

### Advantageous Effects

As apparent from the fore-going, in an information communication technology (ICT)-based unmanned security system according to the present invention, since an information collection unit configured as a composite radar sensor is used, performance of detection may be improved.

In addition, as an Internet of things (IoT)-ICT convergence technology, since a thief, robber, or enemy is detected and an image thereof is captured and transmitted to a smartphone through a long term evolution (LTE) network using a wireless communication method, performance of security may be improved.

According to the present invention, due to an unmanned technology, no-surveillance zones may be reduced and surveillance equipment may be minimized in places with low manpower for surveillance. Furthermore, due to operation in a wireless manner, large-scale foundation work for installing a wired system may not be required and maintenance costs of the wired system may be reduced. In addition, due to a mobile configuration, information may be obtained in real time while moving and an unmanned surveillance device may be instantaneously and remotely controlled, thereby reducing an operational reaction time.

### DESCRIPTION OF DRAWINGS

FIG. 1 is a conceptual view of an ICT-based unmanned security system according to an embodiment of the present invention.

FIG. 2 is a conceptual view of unmanned surveillance devices and mobile devices of the ICT-based unmanned security system according to an embodiment of the present invention.

FIG. 3 is a front view of an intruder surveillance device.

FIG. 4 is a front view of a camera of an unmanned security system according to another embodiment of the present invention.

### BEST MODE

An information communication technology (ICT)-based unmanned security system according to an embodiment of the present invention will now be described in detail with reference to the attached drawings.

In this specification, 1) the shapes, sizes, ratios, angles, numbers, etc. of elements illustrated in the drawings are provided as examples and can be slightly changed. 2) The drawings are illustrated in view of an observer and thus the directions or orientations of the drawings can be variously changed depending on the position of the observer. 3) Like reference numerals between different drawings can denote like elements. 4) Unless defined otherwise, the terms “includes”, “comprises”, “has”, “consists of”, etc. specify the presence of stated elements but do not preclude the presence or addition of other elements. 5) The singular forms “a”, “an”, and “the” are intended to encompass the plural forms as well. 6) Even when described without using an expression such as “approximately” or “practically”, shapes, size comparisons, spatial correlations, etc. are construed to include typical error ranges. 7) The expressions “after”, “before”, “next”, “subsequently”, “at this time”, etc. are not used to limit temporal locations. 8) The terms “first”, “second”, “third”, etc. are used selectively, interchangeably, or repeatedly only to distinguish elements, but the elements are not limited by these terms. 9) When an element is referred to as being “on”, “under”, “next to”, or “beside” another element, one or more intervening elements can be present therebetween unless the expression “directly” is used. 10) When parts are listed using the term “or”, they are intended to include the parts used solely and in combination. However, when the parts are listed using the term “either . . . or”, they are intended to include only the parts used solely.

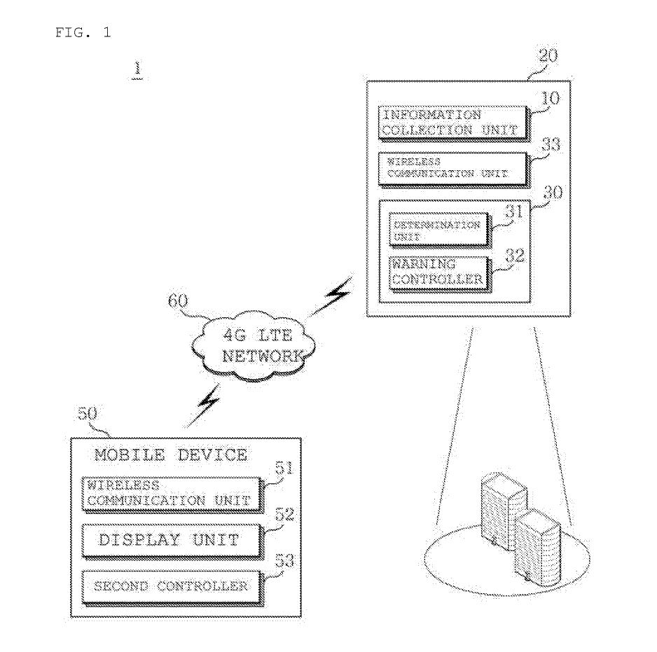

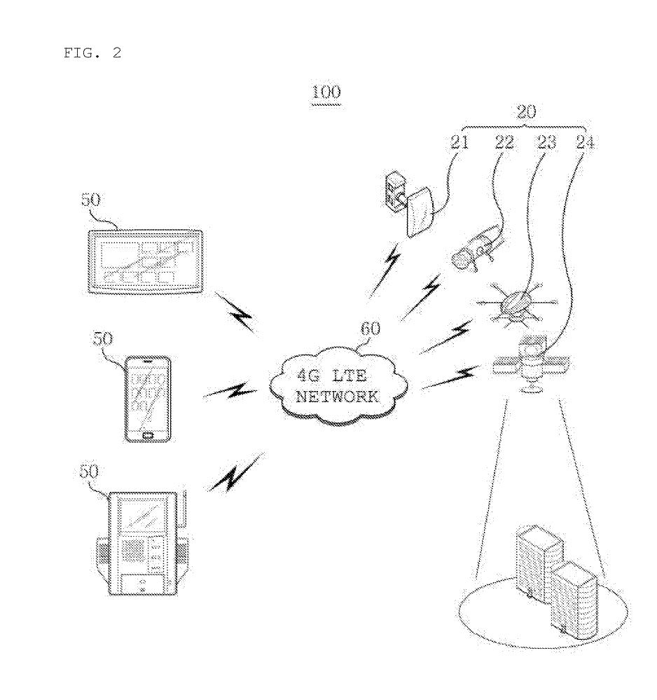

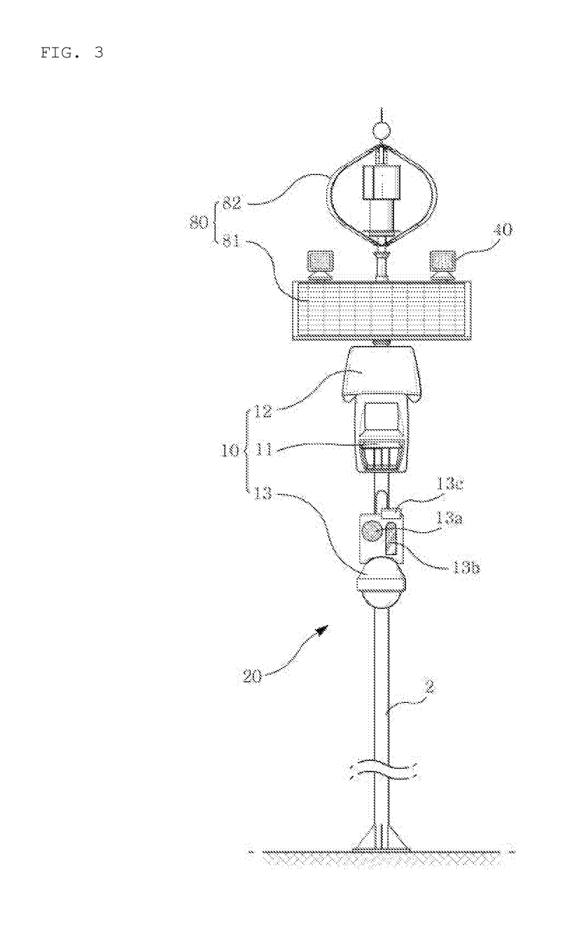

FIG. 1 is a conceptual view of an ICT-based unmanned security system according to an embodiment of the present invention, FIG. 2 is a conceptual view of unmanned surveillance devices and mobile devices of the ICT-based unmanned security system according to an embodiment of the present invention, and FIG. 3 is a front view of an intruder surveillance device.

As illustrated in FIGS. 1 to 3, the ICT-based unmanned security system according to an embodiment of the present invention includes an unmanned surveillance device 20 and a mobile device 50. The unmanned surveillance device 20 not only provides photos and text messages to a surveillant immediately after an intruder enters but also issues a warning to the intruder by shining a light on the intruder, based on cooperation between an information collection unit 10 configured as an intelligent sensor such as a fusion sensor, an Internet protocol (IP) camera 13, and a light-emitting means 40 configured as a light-emitting diode (LED) or the like. Preferably, the fusion sensor which is an intelligent sensor serving as a core element of the unmanned surveillance device 20 includes one microwave sensor (radar sensor) capable of accurately detecting the size and motion of an object, and two thermal infrared sensors capable of sensitively detecting temperature variation. The unmanned surveillance device 20 has embedded software and a high-performance microchip and a variety of motion patterns of people and animals are stored in the sensors. That is, a person in a control room does not watch a closed-circuit television (CCTV) monitor to detect intrusion and, instead, a first controller 30 autonomously determines an intruder if an object over 40 kg moves at 0.1 meter per second (m/s) or faster. When the unmanned surveillance device 20 was installed and tested, a detection range thereof was up to 200 m on flat land and from 15 to 35 m on a slope, and an intruder detection rate was over 99%.

The unmanned surveillance device 20 includes the information collection unit 10, a surveillance device wireless communication unit 33, and the first controller 30, and the first controller 30 includes a determination unit 31 and a warning controller 32. The surveillance device wireless communication unit 33 may wirelessly transmit and receive information through a fourth-generation (4G) long term evolution (LTE) network 60 using LTE communication. Although a wireless communication method using a 4G LTE network is described as an example in the present invention, other wireless communication methods are also usable. The first controller 30 may control all the other elements included in the unmanned surveillance device 20. The first controller 30 may transmit peripheral status information collected by the information collection unit 10, through the surveillance device wireless communication unit 33.

When the mobile device 50 transmits a remote control signal through a mobile device wireless communication unit using LTE communication, the first controller 30 may receive the remote control signal through the surveillance device wireless communication unit 33, and drive the unmanned surveillance device 20 based on the received remote control signal.

When a plurality of mobile devices 50 are present, the first controller 30 may wirelessly and simultaneously transmit the collected peripheral status information to the plurality of mobile devices 50 using LTE communication. As such, a plurality of administrators or the like may simultaneously check the collected peripheral status information.

The mobile device 50 includes the mobile device wireless communication unit 51, a display unit 52, and a second controller 53. The mobile device 50 may refer to all mobile devices capable of transmitting and receiving information using LTE communication, e.g., a mobile phone, smartphone, notebook computer, digital multimedia broadcasting (DMB) receiver, personal digital assistant (PDA), portable multimedia player (PMP), and navigation system.

The mobile device wireless communication unit 51 may wirelessly transmit and receive information through the 4G LTE network 60 using LTE communication.

The display unit 52 may display (output) information processed by the mobile device 50. For example, the display unit 52 may include at least one selected from among a liquid crystal display (LCD), thin film transistor-liquid crystal display (TFT LCD), organic light-emitting diode (OLED), flexible display, and three-dimensional (3D) display.

The second controller 53 may wirelessly receive the peripheral status information from the unmanned surveillance device 20 through the mobile device wireless communication unit 51, and display the peripheral status information on the display unit 52.

When a remote control signal for controlling the unmanned surveillance device 20 is input through a user input unit (not shown) such as a keypad, mouse, or touchscreen, the second controller 53 transmits the remote control signal to the unmanned surveillance device 20 through the mobile device wireless communication unit 51. The remote control signal is a signal for controlling operation of the unmanned surveillance device 20. For example, the remote control signal may be a signal for controlling motion, power, information transmission, etc. of the unmanned surveillance device 20.

As illustrated in FIG. 2, the unmanned surveillance device 20 may be configured in various forms, e.g., an unmanned reconnaissance aircraft 24, an unmanned intelligent flying robot 23, an unmanned camera 22, and a detection sensor 21. Each unmanned surveillance device 20 may include an information collection unit, a wireless communication unit, and a controller.

The mobile device 50 includes all mobile devices capable of transmitting and receiving information using LTE communication, e.g., a mobile phone, smartphone, notebook computer, DMB receiver, PDA, PMP, and navigation system.

When a remote control signal for controlling the unmanned surveillance device 20 is input through a user input unit (not shown), the mobile device 50 transmits the remote control signal to the unmanned surveillance device 20 through a wireless communication unit (not shown) for a mobile device. The remote control signal is a signal for controlling operation of the unmanned surveillance device 20.

When the remote control signal is received through the wireless communication unit (not shown) for a mobile device, the unmanned surveillance device 20 may operate based on the received remote control signal. For example, if the remote control signal is a signal for moving the unmanned intelligent flying robot 23, the controller of the unmanned intelligent flying robot 23 controls the unmanned intelligent flying robot 23 to move to a certain area based on the remote control signal. As such, a user of a mobile device (e.g., a person in charge of reconnaissance) may remotely control a surveillance device to monitor a desired area, using the mobile device. As such, an administrator or the like may check information in real time and instantaneously issue an instruction to monitor a desired area.

As illustrated in FIGS. 1 and 3, the unmanned surveillance device 20 includes a body 2 having a pole shape standing on the ground, and a wind power generator 82, a solar power generator 81, the information collection unit 10 configured as the fusion sensor, and the light-emitting means 40, which are mounted on the body 2.

The body 2 may be configured in a pole shape standing on the ground, and the shape thereof may be variously changed depending on an installation location thereof. When the unmanned reconnaissance aircraft 24, the unmanned intelligent flying robot 23, the unmanned camera 22, or the detection sensor 21 is used as the unmanned surveillance device 20 as described above, the shape of the body 2 may be correspondingly changed.

The solar power generator 81 and the wind power generator 82 for configuring a power source 80 autonomously generate and supply electricity required to operate the mounted parts. As such, connection of power and communication cables is not necessary and a wild animal control system may be independently installed.

The unmanned security system includes the first controller for determining whether an intruder enters a surveillance area, the light-emitting means 40, the mobile device 50, the 4G LTE network 60, and the power source 80.

The unmanned surveillance device 20 may determine whether an intruder enters a surveillance area, and transmit intrusion information to a user or let the intruder out of the surveillance area. The unmanned surveillance device 20 includes the information collection unit 10 configured as the fusion sensor in which a radar 11 and an infrared sensor 12 for detecting infrared light emitted from an intruder are combined. Additionally, the information collection unit 10 may include the camera 13 for photographing an object. The camera 13 may be integrated with or separated from the fusion sensor configured as the information collection unit 10. The radar 11 included in the fusion sensor excels at detecting the size and motion of every object and is useful in terms of detection speed and detection size but is not useful in terms of temperature, but the thermal infrared sensor 12 for sensing motion of an object by detecting infrared light emitted from a person or animal is useful in terms of temperature and is not useful in terms of detection speed. Therefore, the fusion sensor obtained by combining the two sensors uses only advantages of each sensor to improve the performance thereof, and thus a problem such as detection failure or false detection rarely occurs. The numbers of the radars 11 and the thermal infrared sensors 12 may be selectively set by the user depending on an environment of the surveillance area. The camera 13 is a smart IP camera and is capable of capturing an image of 1,000,000 to 10,000,000 pixels (preferably 1,000,000 pixels), and a frame rate is preferably 1 to 30 frames per second (fps). Like a CC camera, the camera 13 has a driving device embedded therein to rotate by up to 355°, and has a record function and a bidirectional audio function. Additionally, an external motion sensor may be mounted on the smart IP camera. In the present invention, one radar 11 and two infrared sensors 12 are combined and are interlocked to operate in a harsh outdoor environment, and the embedded software is used to verify a detected object by comparing a motion pattern of an intruder and thermal infrared light emitted therefrom, thereby maximizing reliability.

The unmanned surveillance device 20 includes the first controller 30 for receiving a signal detected by the information collection unit 10 configured as the fusion sensor, determining whether the detection object is an intruder, and generating a control signal if the detection object is an intruder. The first controller 30 may be integrally included in the unmanned surveillance device 20 as illustrated in FIG. 1, or may be included a control server. The first controller 30 may determine whether a detected object is an intruder, by comparing the detected information

to an intruder determination criterion preset in the fusion sensor using the embedded software and an algorithm of the high-performance microchip integrally configured in the fusion sensor. That is, preferably, the first controller 30 is integrally included in the information collection unit 10. In particular, the sensors are interlocked using the algorithm and the embedded software to operate in a harsh outdoor environment, and a detected object is verified by comparing a motion pattern of an intruder and thermal infrared light emitted therefrom, thereby maximizing reliability. Specifically, malfunction in the natural environment or motion of an object is distinguished and thus the highest reliability is ensured.

The first controller 30 includes the determination unit 31 for receiving a detection signal and image of the information collection unit 10, and the warning controller 32 for controlling emission of the light-emitting means 40. Although the first controller 30 includes the determination unit 31, the warning controller 32, and the surveillance device wireless communication unit 33 in the present invention, the first controller 30 may be integrally included in the information collection unit 10 configured as the fusion sensor, and the fusion sensor may directly determine whether the detected object is an intruder using the algorithm and the embedded software.

The information collection unit 10 collects the peripheral status information using images or detection signals generated by the radar, the infrared sensors, and the camera, and transmits the peripheral status information collected by the information collection unit 10 to the determination unit 31. The determination unit 31 determines whether the detected object is an intruder, based on the collected information. Based on the intruder determination criterion preset in the determination unit 31, if an object over 40 kg moves at 0.1 m/s or faster, the object is determined to be an intruder. The weight and speed values may be changed as desired by the user. When an outline of the object is obtained by the radar and the infrared sensors, a volume thereof is converted into a total weight.

If the detected object is determined to be an intruder, the warning controller 32 turns on the light-emitting means 40 by controlling emission thereof. When the light-emitting means 40 is turned on, light is emitted and a warning message is provided to the intruder by the light. In addition, if the detected object is determined to be an intruder, the warning controller 32 stores an image of the intruder, which is captured by the camera 13, in a storage 13c as a file and operates a speaker 13b and a microphone 13a included in the camera 13. Warning sound may be output through the speaker 13b, and a voice message input by the user through the mobile device 50 may be output through the speaker 13b.

If the intruder is not as a person but a wild animal and the unmanned security system is used as a wild animal control system, the warning controller 32 counts the number of times that the determination unit 31 determines wild animals, per time zone, and calculates a time zone when wild animals often appear. The luminance of light emitted from the light-emitting means 40 in the time zone when wild animals often appear is set to be higher than the luminance of light emitted in the other time zones, thereby increasing the effect of keeping wild animals away. Alternatively, the number of times that the light-emitting means 40 emits light may be increased in the time zone when wild animals often appear. For example, light of the same luminance may be repeatedly emitted twice or more whenever a wild animal is detected once, thereby increasing the effect of keeping wild animals away.

The mobile device 50 includes the mobile device wireless communication unit 51 for wirelessly transmitting and receiving information to the surveillance device wireless communication unit 33 using LTE communication, and the display unit 52 for displaying the peripheral status information received through the mobile device wireless communication unit 51, to be viewed by the user. The mobile device 50 further includes the second controller 53 for generating a control signal for controlling the light-emitting means 40 by the user based on the image information displayed on the display unit 52, and the control signal generated by the second controller 53 is transmitted to the surveillance device wireless communication unit 33 though the mobile device wireless communication unit 51. The control signal received by the surveillance device wireless communication unit 33 is transmitted to the warning controller 32, and operation of the light-emitting means 40 is controlled based on the control signal.

When a plurality of mobile devices 50 are present, the wild animal surveillance device 20 may wirelessly and simultaneously transmit the collected peripheral status information to the plurality of mobile devices 50 using LTE communication.

The display unit 52 may display (output) information processed by the mobile device 50. For example, the display unit 52 may include at least one selected from among an LCD, TFT LCD, OLED, flexible display, and 3D display.

When a remote control signal for controlling the unmanned surveillance device 20 is input through a user input unit (not shown) such as a keypad, mouse, or touchscreen, the second controller 53 of the mobile device 50 transmits the remote control signal to the surveillance device wireless communication unit 33 of the unmanned surveillance device through the mobile device wireless communication unit 51. The remote control signal is a signal for controlling operation of the unmanned surveillance device 20. For example, the remote control signal may be a signal for controlling motion, power, information transmission, etc. of the unmanned surveillance device 20.

Since an ICT-based unmanned surveillance device operates in a wireless manner, large-scale foundation work for installing a wired system may not be required and maintenance costs of the wired system may be reduced. In addition, since an ICT-based wild animal surveillance device is configured to be mobile, information may be obtained in real time while moving and the unmanned surveillance device 20 may be instantaneously and remotely controlled, thereby reducing a reaction time required to displace wild animals.

Preferably, the light-emitting means 40 is configured as a high-luminance LED searchlight. Although the light-emitting means 40 operates at about 55W, light is focused at a beam angle of 6° or less and proceeds 300 m or more and the user may accurately target the light on the eyes of a boar while monitoring the mobile device 50.

The light-emitting means 40 may be integrated with or separated from the wild animal surveillance device 20. When the light-emitting means 40 is separated from the wild animal surveillance device 20, a cable connection may be established therebetween to transmit and receive an operation signal.

The unmanned surveillance device 20 includes the solar power generator 81 for generating electricity required to operate the system using solar energy and storing the electricity. The solar power generator 81 includes a solar panel for absorbing sunlight to convert light energy into electricity, and a charger for charging the electricity generated by the solar panel, in a battery. The electricity charged in the charger of the solar power generator 81 is used to supply electricity required to operate each element of the system. In the ICT-based unmanned security system, since the light-emitting means operates only if a signal detected by the unmanned surveillance device 20 indicates an intruder, power consumption is low and thus electricity may be sufficiently supplied by only the solar power generator 81.

Although not shown in the drawings, the present invention may supply electricity using a power generator other than the solar power generator 81 and the wind power generator 82, by connecting an additional battery, or by connecting an external power cable.

An operation process of the above-described ICT-based unmanned security system according to the first embodiment of the present invention is as described below.

When an intruder appears in a surveillance area, the fusion sensor including the radar 11, the infrared sensors 12, and the camera 13 detects the intruder. A signal detected by the information collection unit 10 configured as the fusion sensor is transmitted to the first controller 30. The signal transmitted to the first controller 30 is stored, and the stored signal is transmitted to the determination unit 31 to determine whether the transmitted information indicates an intruder. If the determination unit 31 determines that the captured image signal indicates an intruder, the surveillance device wireless communication unit 33 transmits the signal to the mobile device wireless communication unit 51 of the mobile device 50 using the 4G LTE network 60. In this case, the mobile device 50 sounds a detection alarm, receives a message, and displays the image signal received through the mobile device wireless communication unit 51 on the display unit 52.

The user checks the image displayed on the display unit 52 and generates a control signal for automatically or manually operating the light-emitting means 40. The generated control signal is transmitted to the surveillance device wireless communication unit 33 through the mobile device wireless communication unit 51, and the control signal transmitted to the surveillance device wireless communication unit 33 is transmitted to the warning controller 32 to operate the light-emitting means to emit light or operate the speaker 13b to output warning sound.

In some cases, if the determination unit 31 determines that the captured image indicates an intruder, a control signal may be instantaneously transmitted to the warning controller 32 to control the light-emitting means 40 to emit light. A process from when the fusion sensor captures the image to when the light-emitting means 40 emits light may be monitored by the user on the display unit 52 of the mobile device 50. In this case, if the user desires, the mobile device 50 may manually generate a control signal to control the light-emitting means 40 to emit light using a wireless communication method.

For example, the ICT-based unmanned security system may be used as a wild animal control system particularly for boars. It is reported that boars habitually move a lot around 5:00, 18:00 to 19:00, and 23:00. To improve the efficiency of keeping boars away in these time zones when boars often appear, the warning controller 32 may count the number of times that a detection signal is generated, per time zone to calculate a time zone when wild animals often appear, and may control the light-emitting means 40 to emit light of a higher luminance or emit light a larger number of times in the time zone when wild animals often appear, compared to the other time zones.

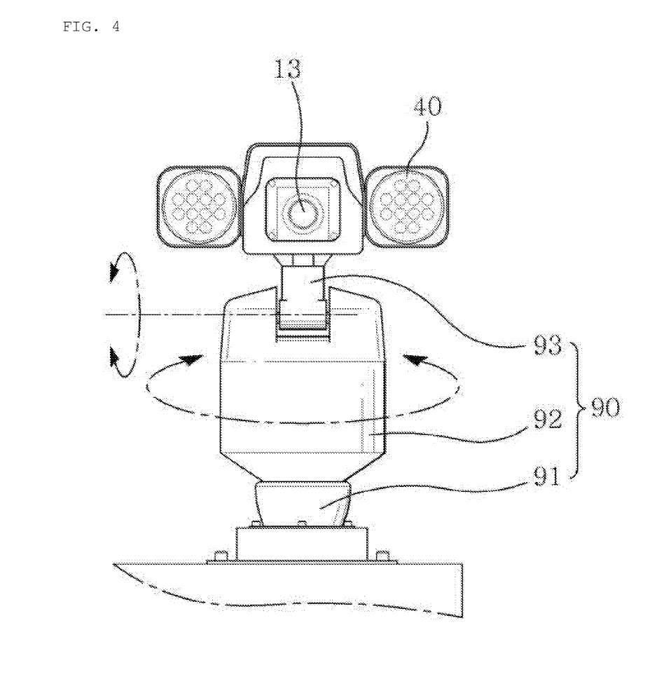

FIG. 4 is a front view of a camera of an unmanned security system according to another embodiment of the present invention. In the unmanned security system according to another embodiment of the present invention, as illustrated in FIG. 4, a composite hinge 90 capable of rotating horizontally and vertically is mounted on a certain part of the body 2, and the camera 13 and the light-emitting means 40 are mounted on the composite hinge 90.

The composite hinge 90 includes a fixed part 91 fixed to the certain part of the body 2, a first rotatable part 92 rotatably mounted on the fixed part 91, and a second rotatable part 93 rotatably mounted on the first rotatable part 92 to rotate about a rotation axis crossing the rotation axis of the first rotatable part 92. A motor (not shown) for generating rotational force of the first and second rotatable parts 92 and 93 by receiving a signal of a controller is mounted on the first and second rotatable parts 92 and 93.

By rotating the first and second rotatable parts 92 and 93 based on the location of an intruder, wherever the intruder appears, the camera 13 and the light-emitting means 40 are driven to face the intruder. To this end, the composite hinge 90 may operate by receiving a control signal for issuing an instruction to move toward the location of the intruder based on information detected by the first controller 30, or by receiving a control signal input to the mobile device 50 by a user. The structure in which the camera 13 and the light-emitting means 40 are mounted on the composite hinge 90 may be variously changed as in the previous embodiment of the present invention.

As described above, the ICT-based unmanned security system according to the present invention may receive a detection signal not using a wireless communication method but using a cable depending on an installation location thereof. That is, a plurality of unmanned surveillance devices 20 may be installed within a sightline distance of 1 km, a detection signal received therefrom may be transmitted to the mobile device 50 such as a smartphone, and the light-emitting means 40 may automatically follow and emit light to a detected object.

The unmanned surveillance device 20 autonomously identifies a wild animal and wirelessly transmits the identification information. Since the unmanned surveillance device 20 merely determines whether an animal is detected and wirelessly transmits the animal detection information, the unmanned surveillance device 20 may be easily installed at a place where wild animals appear. When the detection signal is transmitted to the camera 13, the camera 13 automatically moves toward the detected location and then the light-emitting means 40 automatically turns on an LED searchlight.

As a structure using the Internet of things (IoT), the radar sensor and the thermal infrared sensors for configuring the information collection unit 10 of the unmanned surveillance device 20 cooperate to autonomously detect an animal or person based on the size, motion, and motion pattern thereof, and to autonomously and automatically notify the user through the Internet, the camera 13 moves and automatically performs a recording operation, and the light-emitting means 40 automatically emits light. Through the Internet, the light-emitting means 40 may be turned on/off and the speaker 13b may output sound that wild animals dislike or output a voice signal of the user.

The light-emitting means 40 may be integrally attached to sides of the camera 13.

A sensor included in the information collection unit 10 has a detectable range of 15 m when mounted at a height equal to or less than 1.2 m, has a detectable range of 35 m when mounted at a height of 3 to 4 m, and has a detectable range of 200 m when mounted at a height of 1 m.

In addition, a telecommunication cable may not be installed in consideration of a harsh outdoor environment and the unmanned surveillance device 20 may autonomously ignore insignificant objects and detect and displace only an intruder having a size greater than a preset size using IoT and ICT technology. For example, since a boar has a weight of about 100 to 300 kg, if only objects over 80 kg are detected, only boars may be displaced without causing a false alarm.

Although the unmanned surveillance device 20 for detecting an intruder is currently configured to detect a size corresponding to 40 kg or above, a desired size may be set. That is, to detect elks, the data set in the determination unit 31 may be changed in consideration of the size of elks.

While the present invention has been particularly shown and described with reference to embodiments thereof, it will be understood by one of ordinary skill in the art that various changes in form and details may be made therein without departing from the spirit and scope of the present invention as defined by the following claims.

1. An information communication technology (ICT)-based unmanned security system comprising:
an unmanned surveillance device (20) comprising an information collection unit for collecting peripheral status information, a surveillance device wireless communication unit for wirelessly transmitting and receiving information using a long term evolution (LTE) communication method, and a first controller for transmitting or receiving the information collected by the information collection unit, through the surveillance device wireless communication unit; and
a mobile device (50) comprising a mobile device wireless communication unit for wirelessly transmitting and receiving information to and from the surveillance device wireless communication unit, and a second controller for displaying the peripheral status information received through the mobile device wireless communication unit, on a display unit.

2. The ICT-based unmanned security system according to claim 1, wherein, when a remote control signal is transmitted through the mobile device wireless communication unit, the remote control signal is received through the surveillance device wireless communication unit and the unmanned surveillance device is driven based on the received remote control signal.

3. The ICT-based unmanned security system according to claim 1, wherein, when a plurality of mobile devices are present, the unmanned surveillance device simultaneously transmits the collected peripheral status information to the plurality of mobile devices using LTE communication.

4. The ICT-based unmanned security system according to claim 1, wherein the unmanned surveillance device (20)) comprises:
a power source (80) mounted on a body (2) to autonomously generate and supply electricity required for operation;
the information collection unit (10) mounted on the body (2) and configured as a fusion sensor including a radar (11) for monitoring a surveillance area and an infrared sensor (12) for detecting infrared light; and
the first controller (30) for receiving a signal detected by the information collection unit (10), determining whether a detected object is an intruder, and transmitting or receiving the collected information through the surveillance device wireless communication unit if the detected object corresponds to a preset intruder determination criterion.

5. The ICT-based unmanned security system according to claim 4, wherein the first controller (30) is integrated with the body (2) and comprises embedded software in which the intruder determination criterion is set as a case when an object over 40 kg moves at 0.1 meter per second (m/s) or faster, to generate a detection signal.

6. The ICT-based unmanned security system according to claim 5, wherein a light-emitting means (40) for emitting light if the first controller (30) determines an intruder is further mounted on the body (2).

7. The ICT-based unmanned security system according to claim 6, wherein the first controller (30) comprises:
a determination unit (31) having stored the intruder determination criterion therein to receive a signal generated by the information collection unit (10), to determine whether a detected object is an intruder, and to generate a detection signal; and
a warning controller (32) for controlling emission of the light-emitting means (40) based on determination of the determination unit (31).

8. The ICT-based unmanned security system according to claim 6, wherein the light-emitting means (40) comprises a high-luminance light-emitting diode (LED) searchlight.

9. The ICT-based unmanned security system according to claim 4, wherein the information collection unit (10) further comprises a camera (13) for capturing an image of a surveillance area or an intruding object.

10. The ICT-based unmanned security system according to claim 9, wherein a composite hinge (90) is further mounted on the body (2),
wherein the composite hinge (90) comprises:
a fixed part (91) mounted on the body (2);
a first rotatable part (92) rotatably mounted on the fixed part (91); and
a second rotatable part (93) rotatably mounted on the first rotatable part (92) to rotate about a rotation axis crossing the rotation axis of the first rotatable part (92), and
wherein the camera (13) and the light-emitting means (40) for emitting light are mounted on the second rotatable part (93).

11. The ICT-based unmanned security system according to claim 9, wherein the camera (13) has a speaker and a microphone embedded therein and captures an image if the first controller (30) determines that the detected object is an intruder.

12. The ICT-based unmanned security system according to claim 4, wherein the power source (80) comprises:
a solar power generator (81) mounted on the body (2) to generate electricity using solar energy and to store the electricity; and
a wind power generator (82) mounted on the body (2) to generate electricity using wind power and to store the electricity.
